(19) United States
(12) Patent Application Publication
(10) Pub. No.: US 2017/0014212 A1
(43) Pub. Date: Jan. 19, 2017

(54) APPARATUS AND METHOD FOR MANUFACTURING DENTURES

(71) Applicant: ULTRADENT PRODUCTS, INC., South Jordan, UT (US)

(72) Inventor: Dan E. Fischer, Sandy, UT (US)

(73) Assignee: Ultradent Products, Inc., South Kordon, UT (US)

(21) Appl. No.: 15/115,887

(22) PCT Filed: Feb. 4, 2015
(86) PCT No.: PCT/US2015/014397

§ 371 Date: Aug. 1, 2016

Related U.S. Application Data
(60) Provisional application No. 61/935,710, filed on Feb. 4, 2014.

(51) Int. Cl. A61C 13/08; A61C 13/107; A61C 13/36

(52) U.S. Cl. CPC A61C 13/081; A61C 13/1016; A61C 13/082; A61C 13/0001

(57) ABSTRACT

Methods for manufacturing a denture including providing a cavity having a plurality of wells formed therein for receiving denture teeth, inserting denture teeth into the wells so that distal coronal aspects face into the wells, positioning the cavity over a core to form a molding void therebetween, in which the exposed proximal aspects of the denture teeth are in the molding void, and introducing a molding material into the molding void to envelope the proximal aspects of the denture teeth and form a denture base upon at least partial setting of the molding material. Once set, the denture base with denture teeth retained therein may be removed from the cavity and core. Using such methods, a kit of differently sized prefabricated dentures in which the denture bases comprise a plastically deformable material may be provided, an appropriate denture selected, and semi-customized to a patient.

### BACKGROUND OF THE INVENTION

1. The Field of the Invention

The present invention relates to dentures, as well as methods and apparatus for their manufacture.

2. The Relevant Technology

Conventional dentures are fabricated using a complex and expensive process where the patient is required to visit the dental practitioner several times (e.g., 4 to 5 times) over a period of days or weeks for taking measurements, impressions, evaluating fit of lab formed custom devices, etc. For example, a mold of the patient's mouth may be prepared during a first visit. Thereafter, the mold is poured in stone. This then has a rough base fabricated thereon, which is lined with a wax rim. This structure is then further adjusted during another appointment with the patient to determine various important dimensions that must be customized to the individual patient. Plastic or ceramic teeth may then be set into the wax rim, which may then be tried in the patient's mouth during another appointment, which teeth may be adjusted as needed. After this visit, the structure is placed in a specialized flask, filled with plaster which hardens to hold the teeth in place, and the wax rim is melted out with the teeth being held by the stone. Thermoset or chemical-set acrylic is packed against the teeth in the form. Upon curing, the stone is broken away, and the custom denture is removed after which the resulting denture may be cleaned and polished. At this point, during another patient appointment, the denture is tried for fit. Many times, the custom denture does not fit adequately due to dimensional changes that occur during the taking of the impression, laboratory processing, and so forth. As a result, a custom relining, with occlusal adjustment is often required.

Because of the complexity and many office visits required by such processes, the cost to prepare conventional dentures is relatively high, making them inaccessible to many who would benefit therefrom, due to the cost and complexity of the conventional fabrication process.

As such, it would be beneficial to provide simplified processes that could be used in the manufacture of dentures, and that would greatly reduce the time and cost required to provide a denture to a patient.

### BRIEF SUMMARY OF THE PREFERRED EMBODIMENTS

According to an embodiment, a kit may be provided for use in providing a semi-custom-fitted denture to a patient. Such a kit may comprise a plurality of prefabricated dentures, each of a different size, each prefabricated denture including a plurality of denture teeth, and a denture base within which the denture teeth are at least partially embedded. For example, such a kit may include 3 or more, 4 or more, or 5 or more differently sized prefabricated dentures. The denture base may comprise a material that is becomes plastically deformable at temperatures of from about 80° C. and about 150° C. For example, the denture base may comprise a material that is not plastically deformable at body temperature, but becomes plastically deformable at a temperature somewhat elevated relative to body temperature (e.g., that becomes plastically deformable at a temperature greater than body temperature and less than about 150° C., or less than about 100° C.) so as to permit semi-customization of the prefabricated denture (e.g., by submerging in hot water) to an alveolar ridge of a patient, or to a stone mold of the alveolar ridge of the patient.

For example, according to such an embodiment, the practitioner may select a prefabricated denture providing the best fit available from among the plurality of differently sized dentures. The selected denture may be further customized by removing portions of the denture base as desired to improve the fit characteristics relative to the patient's edentulous alveolar ridge, or a stone mold thereof. The selected denture may receive cuts or slits to enable it to be more easily stretched, widened, or narrowed, as needed. In addition, because the denture base is formed of a material that becomes plastically deformable (e.g., upon heating), the denture base may be heated and plastically deformed so as to better conform to the patient's anatomy, resulting in a semi-custom fitted denture once the denture is no longer plastically deformable (e.g., upon cooling). Such semi-custom solutions do not require the making of any custom molded wax models, or multiple visits to a practitioner, each of which are typically needed in fabricating a conventional fully customized denture.

Such prefabricated dentures of different sizes may be mass manufactured under carefully controlled conditions (e.g., in a factory) by various methods (e.g., using injection molding). According to an embodiment, a method for manufacturing a denture comprising a denture base and one or more denture teeth retained therein may include placing one or more denture teeth into corresponding wells in a cavity of a mold such that distal coronal aspects of each of the denture teeth are disposed within the corresponding well, and proximal aspects remain exposed. The cavity with its retained denture teeth may be positioned opposing a core of the mold, the core representing aspects of the alveolar ridge. By so positioning the core and cavity of the mold, a molding void is formed between the core and cavity, and the aspects of the alveolar ridge and the aspects of the denture teeth are exposed within the molding void. The molding void is at least partially filled with a molding material to form a denture base that envelops the proximal aspects of the denture teeth. The molding material may be set (i.e., hardened), to form a denture including the denture teeth retained within the denture base. The molding material may advantageously be rendered plastically deformable after being set (e.g., by heating) so that the denture base can be plastically deformed and semi-customized to an alveolar ridge of a particular person. Because the denture base is formed in more than one size, a selected denture may be semi-customized, and the molding material may reset (e.g., upon cooling to body or ambient temperature), so as to retain the semi-customized shape. Differently sized cavities and correspondingly sized and shaped cores of may be employed to manufacture differently sized dentures.

According to another embodiment of a method of manufacture, one or more tooth-colored molding materials may be introduced into one or more wells in a cavity of a mold. The tooth-colored molding materials may include one or more plastic materials having different colors, shades, hues, and/or tones. The mold may be a multi-component or multi-color mold configured for injection molding two or more different plastic materials. Each well may have the shape of a tooth, and the tooth-colored molding material(s) may at least partially set to form denture teeth that are temporarily retained within the cavity of the mold. The cavity with the retained injection molded denture teeth may be positioned adjacent to a core of the mold, the core including aspects of an alveolar ridge therein, so as to form a molding void between the cavity and core of the mold. The aspects of the alveolar ridge and proximal aspects of the tooth ends of the denture teeth may be exposed within the molding void. The molding void may be at least partially (e.g., completely) filled with a denture-base colored molding material to form a denture base that envelops the exposed proximal aspects of the denture teeth. The denture base colored molding material may be caused or allowed to at least partially set to form a denture including the one or more denture teeth retained in the denture base. Similar to the above described method, differently sized cavities and correspondingly sized and shaped cores may be employed to manufacture differently sized dentures. Furthermore, 3, 4 or more shot processes may include different resin materials (e.g., differently colored) for different denture teeth, so as to form more realistic appearing teeth. For example, different shades of teeth, be they of one color (i.e., monochromatic), or two or more colors in each tooth (i.e., polychromatic) may be provided.

Such an embodiment allows mass production of inexpensive dentures according to a two-shot (or more shot) injection molding technique where both the denture teeth and denture base may be injection molded. For example, according to an embodiment, such denture teeth may be molded inexpensively for use in preparing inexpensive dentures for distribution in developing countries, where cost may be paramount. For increased realism to the denture teeth, two or more tooth-colored molding materials may be employed, either for adjacent teeth (i.e., so that one tooth appears different in color than an adjacent tooth), or within a single given tooth (e.g., to provide polychromatic characteristics within a single tooth). Some embodiments (e.g., those employing pre-fabricated denture teeth inserted into the cavity of the mold as described above) may employ denture teeth that are carefully prepared to be polychromatic, including portions formed of different materials to mimic the coloring, opacity, and translucency of natural teeth.

By way of example, in order to provide 3 or more, 4 or more, or 5 or more prefabricated dentures of different sizes, the cavities employed in such manufacturing may be of corresponding different sizes (e.g., differing in one or more of dental arch length, width, curvature characteristics, etc.). Manufacture of such differently sized prefabricated dentures, each of a different size, allows a practitioner to select a finished denture having the closest fit available from among the provided dentures. The core employed in the manufacturing process may similarly be provided in 3 or more, 4 or more, or 5 or more different sizes, each shaped and sized so as to correspond to one of the cavities. In other words, both the cavities and cores used in manufacturing the prefabricated dentures may be provided in varying sizes, where corresponding sizes of a given cavity and core form a pair, configured to be used together in the molding of a denture.

Advantageously, the prefabricated dentures may thus be injection molded with two or more color plastic molding, using a reusable tool. Such methods and associated tools greatly simplify the procedure for providing a semi-custom denture, as a result of the ability to mass manufacture the dentures from a reusable injection molding tool, by which the dentures may be injection molded in several sizes from which the practitioner may then choose the size providing the best approximate fit, which may subsequently be semi-customized due to the characteristics of the specific materials employed in molding the denture base.

Another embodiment provides a reusable tool for use in mass manufacturing prefabricated dentures of different sizes. Such a tool may include a plurality of denture manufacturing molds, each defining a denture of a different size. Each denture manufacturing mold may comprise a cavity having a plurality of wells formed therein, each well corresponding to a tooth of a denture to be formed. Each denture manufacturing mold may further include a core corresponding in size and shape to the cavity. The core includes aspects of an alveolar ridge, and a molding void is defined between the cavity and corresponding core when the core and cavity are positioned adjacent one another. For example, denture teeth may be inserted into the cavity wells, the proximal aspects being exposed within the molding void, so that a thermoplastic resin, thermoset resin, or denture base molding material injected therein envelopes the proximal aspects. The molding void may be shaped (e.g., as provided by the boundaries provided by the cavity, the core, with its aspects of the alveolar ridge, and exposed proximal aspects of the denture teeth) to form a denture base, including all the gingival features associated with a natural dental arch (e.g., the interdental papilla between adjacent teeth, the scalloped gingival cuff extending across the buccal or labial face of the tooth, etc.). Such denture manufacturing molds may be employed to mass-produce prefabricated dentures in a plurality of sizes, as described above.

By providing such differently sized prefabricated dentures, the practitioner is able to select an appropriately sized denture that can advantageously be further semi-customized. For example, the practitioner may select the smallest sized prefabricated denture fitting over the patient's alveolar ridge or stone model thereof without substantial pressure. Because the denture base is formed of a material that can be rendered plastically deformable (e.g., upon heating to some point above body temperature), the denture base can advantageously be further customized by heating or otherwise rendering the denture base plastically deformable, and then plastically deforming the temporarily plastically deformable material to better approximate a semi-custom fit to the patient's anatomy. In addition, further customization may involve removing portions of the denture base as desired (e.g., cutting away with a knife or other tool such as a dental burr) to better approximate fit to the patient (e.g., before or after semi-customization possible because of temporary plastic deformation characteristics). All this can be accomplished in relatively little time, e.g., in as little as a single visit with the practitioner.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a flowchart illustrating an exemplary method for manufacturing the prefabricated dentures in a plurality of different sizes;

FIG. 1B is a flowchart illustrating an alternative exemplary method for manufacturing the prefabricated dentures in a plurality of different sizes;

FIG. 2A is a perspective view of a plurality of differently sized cavities, including wells formed therein for retaining corresponding denture teeth;

FIG. 2B is a perspective view of a plurality of differently sized cores corresponding in size and shape to the differently sized cavities of FIG. 2A;

FIG. 2C is a perspective view showing an exemplary denture manufacturing mold, including a cavity and a corresponding core which may be positioned adjacent one another to define a molding void for injection molding a denture base;

FIG. 3 shows a perspective view of a selected cavity from FIG. 2A, in which denture teeth are being inserted into corresponding wells of the cavity with distal coronal aspects or ends oriented facing into the wells, and proximal aspects of the denture teeth extending exposed from the wells;

FIGS. 4A-4B show a denture manufacturing mold, including a selected cavity being positioned adjacent a correspondingly shaped and sized core, so as to define a molding void between the alveolar ridge aspects of the core, the cavity, and the proximal aspects of the denture teeth exposed within the molding void;

FIG. 5 is a cross-sectional view through the denture manufacturing mold including the core, cavity, and retained denture teeth showing the molding void defined within the denture manufacturing mold;

FIGS. 6A-6B are perspective views of an exemplary upper denture manufactured using the denture manufacturing mold of FIG. 5;

FIG. 7A is a perspective view of a plurality of differently sized cavities including wells formed therein for retaining corresponding denture teeth, the cavities being configured for use in molding a lower denture;

FIG. 7B is a perspective view of a plurality of differently sized cores corresponding in size and shape to the differently sized cavities of FIG. 7A, for use in molding a lower denture;

FIGS. 8A-8B are perspective views of an exemplary lower denture that may be manufactured using one of the cavities and the corresponding core of FIGS. 7A-7B, respectively;

FIG. 9A shows a plurality of upper dentures, each of a different size in which the denture base of each upper denture is molded from a molding material that may be rendered plastically deformable to permit semi-customization of the denture to an edentulous alveolar ridge of a patient or a stone mold thereof; and

FIG. 9B shows a plurality of lower dentures, each of a different size in which the denture base of each lower denture is molded from a molding material that may be rendered plastically deformable to permit semi-customization of the denture to an edentulous alveolar ridge of a patient or a stone mold thereof.

### DETAILED DESCRIPTION OF THE PREFERRED EMBODIMENTS

### I. Introduction

In one aspect, the invention generally relates to kits for use in forming a semi-custom fitted denture to a patient. Such a kit may include a plurality of prefabricated dentures, each of a different size. Each denture may include a plurality of denture teeth, and a denture base in which the denture teeth are at least partially embedded, where the denture base comprises a material that may be rendered plastically deformable (e.g., that is rendered plastically deformable by heating, at a temperature below 100° C. and above body temperature) to permit semi-customization of the prefabricated dentures to an alveolar ridge of a patient or a stone mold of the alveolar ridge of the patient. Such a kit allows a practitioner to select a prefabricated denture that provides the best available fit from the plurality of provided prefabricated dentures, which selected denture may then be further customized to the actual anatomy of the patient through heating and subsequent plastic deformation of the denture base.

Methods and related tools (e.g., injection molding tools) for mass-manufacturing such prefabricated dentures are also disclosed. For example, such a method may include placing one or more denture teeth into corresponding wells of a cavity of a mold with distal coronal aspects of the denture teeth oriented facing into the wells and the proximal aspects of the denture teeth opposite the distal coronal ends being exposed within the molding void of the mold. In another embodiment, the denture teeth may be molded within the wells by introducing one or more tooth-colored molding materials into the wells and allowing the tooth-colored molding materials to at least partially set to form denture teeth retained within the cavity. Such an embodiment may be considered a “two-shot” or “two-color” molding (more than two-shots may of course be used), where both the denture teeth and denture base may be molded during the manufacturing process (e.g., from different materials).

In either case, with the denture teeth retained in the cavity portion of the mold tool, the cavity may be positioned adjacent a core of the mold, the core including aspects of an alveolar ridge and/or palate, so as to form a molding void between the core, the cavity, and the exposed proximal aspects of the denture teeth. A thermoplastic resin, thermoset resin, or other suitable molding material that can be plastically deformed after being set so as to permit subsequent semi-customization may be introduced into the molding void so as to at least partially fill the molding void, enveloping the proximal aspects of the denture teeth. The molding material may be caused or allowed to at least partially set, hardening to form a denture base within which the denture teeth are retained. The denture base and retained denture teeth may be removed from the core and cavity.

A tool for use in mass manufacturing a denture may include a plurality of denture manufacturing molds, each of a different size (or configured to produce dentures of a different size). Each denture manufacturing mold includes a core and a cavity. The cavity includes a plurality of wells formed therein, the wells corresponding to teeth of a denture to be formed. The core corresponds in size and shape to the cavity, and includes aspects of an alveolar ridge. A molding void is defined between the cavity and the corresponding core when they are positioned adjacent one another. Such denture manufacturing molds are reusable (e.g., as employed in an injection molding apparatus), rather than being destroyed during preparation of each denture.

The methods of manufacture and tools for mass manufacture allows manufacture of the kit including a plurality of preformed dentures of different sizes, which allows the practitioner to select the denture that most closely approximates fit to the alveolar ridge of the particular patient. A stone mold of the patient's mouth, formed, for example, from a dental impression taken of the patient's mouth, may be used to approximate the fit in selecting the denture. In this way, the dentures are not manufactured so as to be fully customized dentures (e.g., requiring custom models which are used to form the denture), but are manufactured in several sizes, from a plurality of cavities and corresponding cores, so that one of the provided prefabricated dentures will provide a close approximation of the patient's alveolar ridge and dental arch. Because the denture base is formed of a plastically deformable material, it can advantageously be further customized to the requirements of the particular patient by plastic deformation. For example, in an embodiment, the denture base may be heated so as to soften a thermoplastic or other molding material. In its plastically deformable state, the practitioner can then manipulate and plastically deform the denture base to more accurately conform to the alveolar ridge or other anatomy of the particular patient. For example, a practitioner may place the plastically deformable denture base onto a stone mold (i.e., model) of the patient's mouth and conform at least a portion of the denture base by pressing against the stone mold. Additionally, the plastically deformable denture base may be placed directly into the patient's mouth and may be pressed against the alveolar ridge and surrounding tissues of the patient to conform the denture base to the patient's mouth.

### II. Exemplary Methods, Kits and Manufacturing Tools

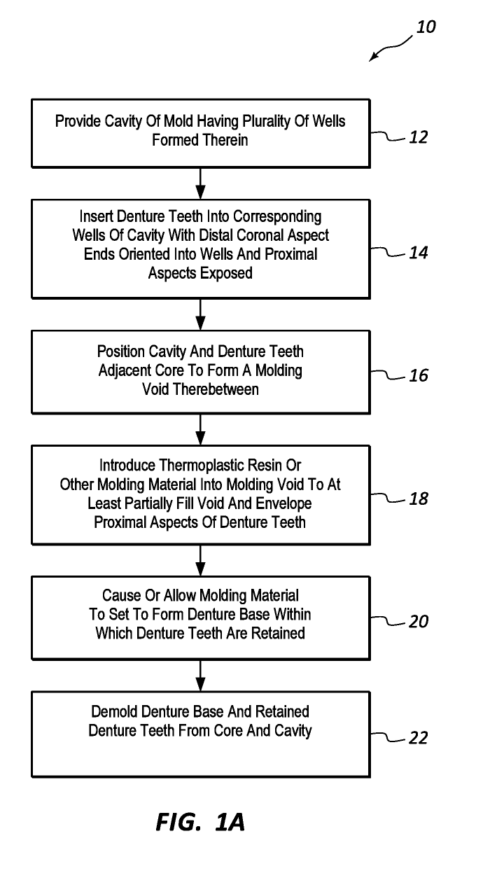

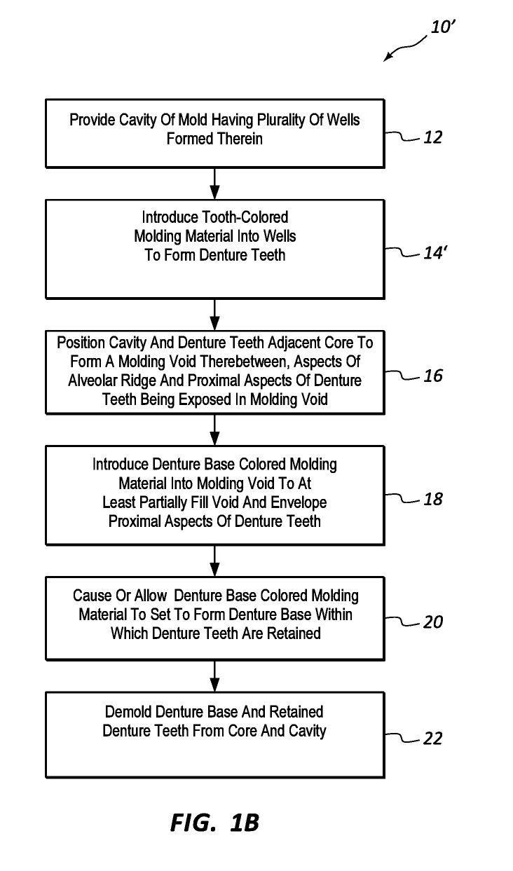

According to one aspect, the present invention provides simplified methods for mass-manufacturing a denture, allowing a denture providing a close fit to the alveolar ridge of a given patient to be selected from a plurality of differently sized dentures, which selected prefabricated denture may then be semi-customized, all within a single, relatively short appointment (e.g., within about an hour or less). Such prefabricated dentures, provided in a plurality of different sizes may be mass-produced under controlled manufacturing conditions (e.g., in a factory), and provided to practitioners, from which a single prefabricated denture may be selected for further customization to a particular patient. FIG. 1A shows a flowchart illustrating an exemplary method 10. For example, as represented at 12, a cavity having a plurality of wells corresponding to teeth of a denture to be formed may be provided. Such a cavity may be one of a plurality of cavities (e.g., 3 or more, 4 or more, or 5 or more) that are of different sizes and/or shapes. Such a plurality of differently sized cavities (and their corresponding cores) allows manufacture of dentures in several sizes, allowing a practitioner to select a prefabricated denture that provides the best fit to the particular patient, selected from the plurality of mass-manufactured, non-custom dentures. The dentures may provide differing dental arch lengths, differing radius of curvature to the dental arch, differing arch widths (e.g., as measured at the ends of the horseshoe shaped arch, etc.). For example, the practitioner may select the denture of the smallest size that will provide a fit to the patient's dental arch and/or alveolar ridge or a stone mold thereof without substantial pressure. Such selection may be based on physical fitting of the dentures to the patient, the stone mold, measurements, etc. The cavities and corresponding cores which form the denture manufacturing molds from which the dentures are prefabricated similarly include the above described size characteristics. In other words, the cavities and cores provide differing dental arch lengths, differing radius of curvature to the dental arch, differing arch widths, etc. that are exhibited in the kit of prefabricated dentures of different sizes.

During manufacture, the denture teeth to be included in the finished denture are inserted into corresponding wells of the cavity, as represented at 14. The denture teeth are inserted so that distal coronal aspects of the denture teeth are oriented facing into the corresponding well, while the opposite proximal aspects of the denture teeth are exposed. The denture teeth may be provided in any desired color shade(s) to mimic that of a natural tooth.

In an embodiment, the denture teeth may be polychromatic, so that their appearance mimics that of natural teeth, exhibiting color, opacity, and translucency characteristics similar to those of natural teeth. For example, such polychromatic denture teeth may exhibit a greater degree of opacity around the root and lower crown portion of the tooth, representative of coloring provided by natural dentin, while the upper crown portion (e.g., the coronal portions) of the denture tooth may exhibit a higher degree of translucency (representative of enamel). Such characteristics are exhibited within natural teeth. Such denture teeth may be formed of any suitable material, such as, but not limited to, ceramics, curable acrylics, and/or dental composites.

Such polychromatic denture teeth may include a portion formed of a dental composite that may be relatively opaque and may include a colorant or dye incorporated therein. The occlusal portions of the denture teeth may comprise an outer layer of another, second, dental composite, placed over the relatively opaque dental composite representative of dentin. The second dental composite (representative of enamel) may be less opaque and more translucent so as to be representative of enamel laid over the first dental composite of the dentin body portion of the denture tooth. The second dental composite of the occlusal portion of the denture tooth may be translucent, similar to natural enamel, allowing some of the coloring of the underlying first dental composite representative of dentin to show through.

The portion of the denture tooth that is representative of dentin may include an opacifying component so as to be visually opaque. Dyes or pigments may be incorporated into the dental composite materials representative of dentin to provide the composite with one of a wide variety of color shades representative of dentin. In an embodiment, dyes or pigments may be incorporated into the dental composite materials representative of enamel.

While any desired colors or color system may be employed, the VITA color identification system is representative. By way of background or example, the VITA shade identification system contains 4 basic color groups (identified as A, B, C, and D) and several degrees of intensity within each basic color group for a total of about 16 color shade/intensity designations. In this system, the color group A designates red-brown and includes intensities A1, A2, A3, A3.5, and A4. Color group B designates red-yellow and includes intensities B1, B2, B3, and B4. Color group C designates gray and includes intensities C1, C2, C3, and C4. Color group D designates reddish gray and includes intensities D2, D3, and D4. The lower the number is in any given color group, the less intense the color. In other words, an A2 shade is a more intense red-brown than an A1 shade. It will be understood that any material used in manufacture of the denture teeth may be colored (e.g., with a dye or pigment), include an opacifier, or be translucent, as desired. For example, the dental composite, ceramic, or other material from which a denture tooth is formed may include one or more dyes or pigments to achieve the desired color shades (e.g., red, brown, yellow, gray, combinations thereof, or any other color dyes or pigments). While the Vita color or shade identification system is referenced above, it will be understood that other systems may also be used.

Referring again to FIG. 1A, once the denture teeth are inserted into the corresponding wells of the cavity, as represented at 16, the cavity and retained denture teeth may be positioned adjacent a corresponding core, which core includes aspects of an alveolar ridge with respect to the cavity, so as to form a molding void between the core, the cavity, and the proximal aspects of the denture teeth exposed within the molding void. As with the cavities, the cores may be provided in a plurality of sizes and shapes, corresponding to the differently sized cavities, and to the differently sized dentures fabricated therefrom. For example, each given cavity may have a corresponding core that it is sized to fit with and correspond to. For example, between corresponding cavities and cores, arch length, curvature, width, etc. of the dental arch defined by the cavity may match that of the alveolar ridge defined by the core.

With the cavity positioned adjacent the core, and the denture teeth temporarily retained within the corresponding wells of the cavity, as represented at 18, a denture-base colored molding material (e.g., a thermoplastic or thermoset resin) may be introduced (e.g., injected) into the molding void defined between the cavity with its retained denture teeth and the core. The introduced molding material may at least partially fill the molding void, enveloping the exposed proximal aspects of the denture teeth. As represented at 20, the molding material is caused or allowed to at least partially set and harden, forming a denture base within which the denture teeth are retained. As represented at 22, the denture base and retained denture teeth may be removed, as the denture base is removed from the reusable cavity and core. Each of the above described steps employed in manufacture may be achieved in a mass-manufacturing environment, under carefully controlled conditions, rather than the one-off production techniques employed in conventional denture manufacture.

While the denture teeth employed in the above described embodiment may be pre-manufactured prior to their insertion into the cavity portion of the denture manufacturing mold, another embodiment of the present invention allows denture teeth to be molded during manufacture of the denture, using the wells of the cavity (e.g., in a two-shot or two-color injection molding process). Of course, more than two-shots may be employed, e.g., where it is desired to employ more than one material for the denture teeth. For example, in such an embodiment the denture teeth may themselves be formed by introducing one or more tooth-colored molding materials into the wells of the cavity, so that the one or more tooth-colored molding materials at least partially set or harden to form denture teeth. A cavity having denture teeth at least partially retained therein may be positioned adjacent a corresponding core, as described above, with distal coronal ends of the denture teeth facing into the wells, and proximal aspect aspects at an opposite end, exposed within the molding void. Introduction of the denture-base colored molding material, at least partial filling of the molding void, subsequent at least partial setting of the denture base molding material, and removing of the denture base and retained denture teeth may proceed in a similar manner as described above.

FIG. 1B shows a flowchart illustrating such a method 10′, where, at 12, a cavity having a plurality of wells formed therein corresponding to teeth of a denture to be formed may be provided. At 14′ a tooth-colored molding material is introduced into one or more of the wells, the tooth-colored molding material at least partially setting to form denture teeth. At 16, a cavity with denture teeth retained therein is positioned adjacent a core to form a molding void defined between the core, the cavity, and exposed proximal aspects of the teeth. The distal coronal aspects of the denture teeth may be retained within the wells of the cavity. At 18, a denture-base colored molding material is introduced into the molding void, at least partially filling the molding void and enveloping the exposed proximal aspects of the denture teeth. At 20, the denture-base colored molding material is at least partially set, forming a denture base within which the denture teeth are retained. At 22, the denture base and retained denture teeth may be removed from the core and cavity. In such an embodiment, introduction of the one or more tooth-colored molding materials into the wells for molding of the denture teeth may be considered the first shot or first color of the two-shot or two-color injection molding process, while introduction of the denture-base colored molding material into the molding void for molding the denture base may be considered the second shot or second color of the two-shot or two-color process. Of course, more than a single tooth-colored molding material may be used in the molding of the denture teeth. Similarly, if desired, more than a single molding material could be used in molding the denture base. As such, 3 or more, or 4 or more, or 5 or more shots could be employed.

Where denture teeth are formed by injection molding, at least two cores could be used, e.g., a first for forming the denture teeth, which would be switched out with a second for forming the denture base. Additionally, it will be apparent that one or more additional cores (or cavities) may be used in forming the denture teeth (e.g., different colors, opaqueness, or plastics to create more realistically appearing denture teeth). The denture teeth may be prepared from a molding material that has increased hardness, toughness, and/or rigidity as compared to the molding material employed in forming the denture base. In an embodiment, the denture teeth may be injection molded after the denture base has already been formed (e.g., by injection molding).

Where one or more tooth-colored molding materials are used to mold the denture teeth within the wells during manufacture of the denture, any suitable tooth-colored molding materials may be used. Examples include, but are not limited to thermoset resins, thermoplastic resins, dental composite resins, curable ceramics, etc. Polycarbonate thermoplastic resins may be a specific example of a thermoplastic resin having sufficient hardness and impact resistance to be used in molding denture teeth within the wells of the cavity.

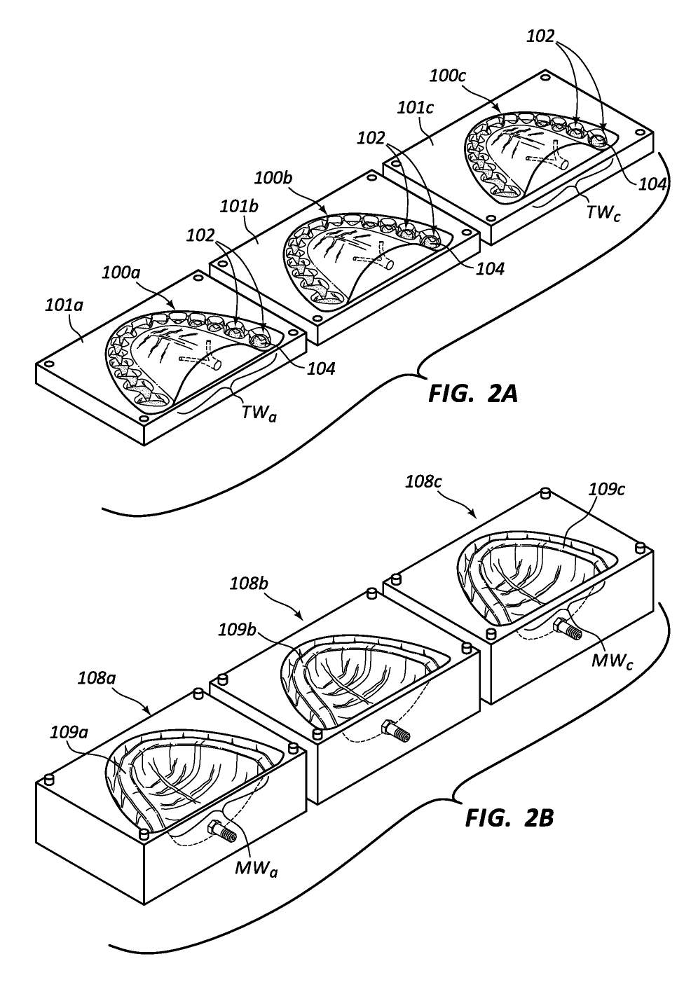

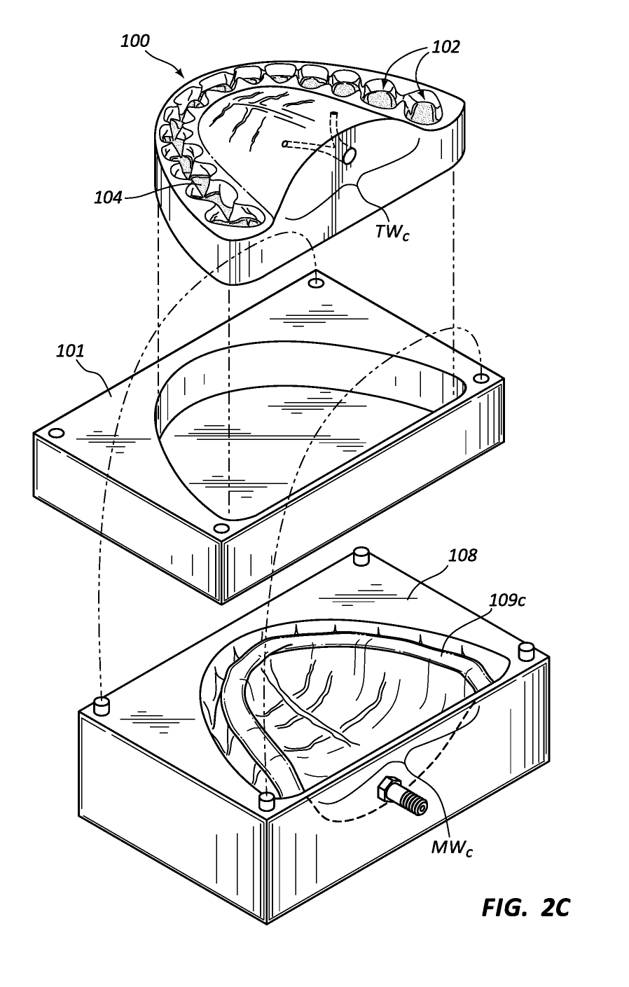

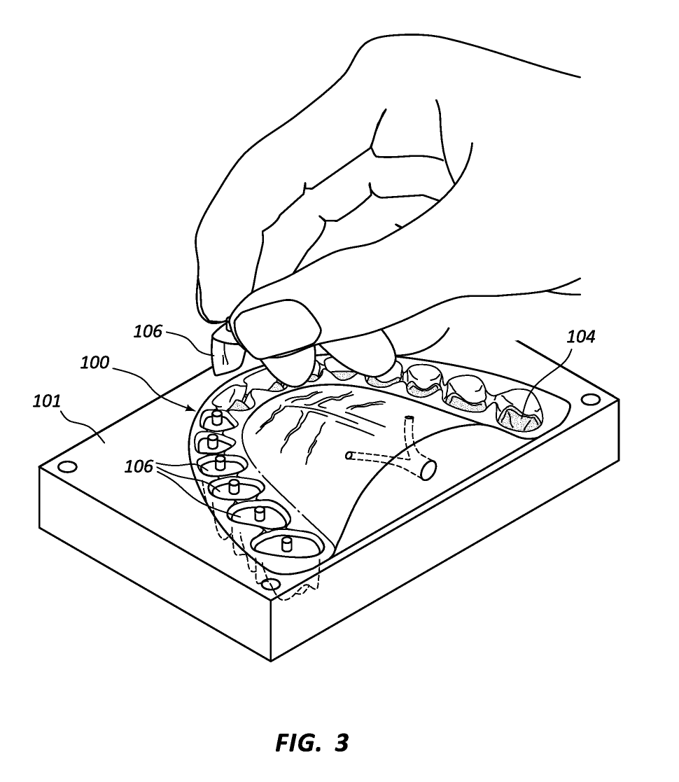

FIG. 2A illustrates a plurality of differently sized cavities 100a-100c, each cavity including a plurality of wells 102 formed within each cavity. Cavities 100a-100c may be formed of a rigid material, such as metal, suitable for use as a portion of a reusable mold in injection molding. As seen in FIG. 2A, at least a portion of the interior surface of wells 102 may be lined with a flexible, elastomeric material 104, such as silicone or a thermoplastic elastomer. Such a liner 104 allows denture teeth 106 to be snapped into wells 102 of cavity 100, as shown in FIG. 3, temporarily retaining denture teeth 106 in wells 102. While manual insertion is shown in FIG. 3, it will readily be appreciated that a mechanism for automated insertion may also be employed.

Providing such a plurality of cavities 100a-100c as seen in FIG. 2A provides a molding tool including differently sized and/or shaped cavities, which allows manufacture of differently sized dentures using a given cavity and its corresponding core, shown in FIG. 2B. FIG. 2B illustrates a plurality of cores 108a-108c, where each core corresponds to a similarly shaped and sized one of cavities 100a-100c. For example, core 108a includes alveolar ridge 109a size and shape characteristics that correspond to those of the dental arch of cavity 100a. For example, as is apparent from FIGS. 2A-2B, cavities and cores 100a-100c and 108a-108c, respectively may include progressively larger dental arch and alveolar ridge widths and/or lengths. In other words, as seen in FIG. 2A, the width TWc between the wells corresponding to the second molars on opposite ends of the dental arch of cavity 100c may be greater than the corresponding width TWa of the dental arch of cavity 100a. Similarly, as seen in FIG. 2B, the width MWc between ends of the horseshoe shaped alveolar ridge 109c of core 108c is greater than the corresponding width MWa of the core of 108a. In addition, as described above, the width MWc between ends of core 108c may correspond to the width TWc at the ends of the horseshoe shaped dental arch of cavity 100c. This correspondence relationship of width, curvature, and ridge/arch length is shown in FIG. 2C.

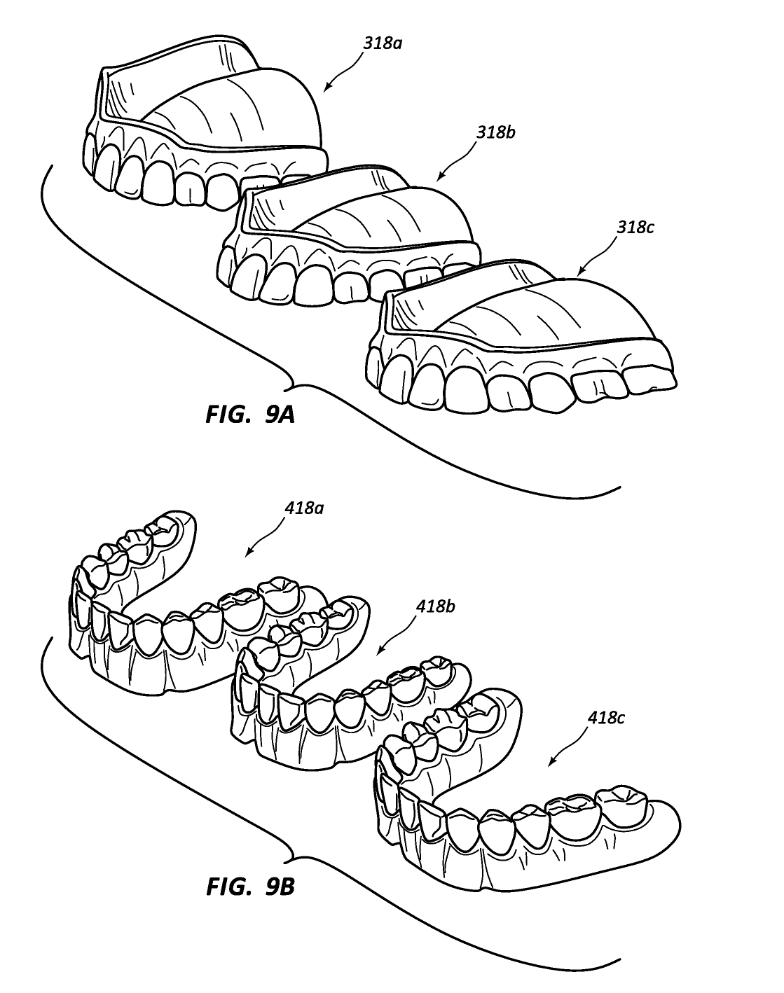

As described above relative to providing a plurality of differently sized cavities, the providing of a plurality of differently sized cores, corresponding to the provided sizes and shapes of the provided cavities, allows mass manufacture of prefabricated dentures in a plurality of sizes, allowing a practitioner to select a prefabricated denture that provides the best fit to and approximation of the patient's alveolar ridge anatomy available from among the plurality of provided prefabricated dentures. Such sets of dentures (e.g., upper and lower) are shown in FIGS. 9A-9B. By selecting the appropriately sized prefabricated denture, the practitioner is able to quickly semi-customize the selected denture to the actual alveolar ridge and other anatomy of the patient. Such selection and semi-customization can be achieved in a single appointment (e.g., all achieved chair-side).

FIG. 3 shows insertion of denture teeth 106 into a selected cavity 100, which occurs during manufacture. Denture teeth 106 may be positioned within wells 102 of cavity 100 with distal coronal aspects of denture teeth 106 oriented facing into well 106, so that the coronal aspects or ends of denture teeth 106 may be surrounded and protected by elastomeric liner 104. The opposite proximal aspects of denture teeth 106 are oppositely disposed, being exposed so that they can be enveloped by the denture-base colored molding material injected into the molding void during molding of the denture base, including the interdental papilla and other gingival features. While shown in FIG. 3 being achieved manually, it will be readily appreciated that an automated insertion mechanism may alternatively be employed.

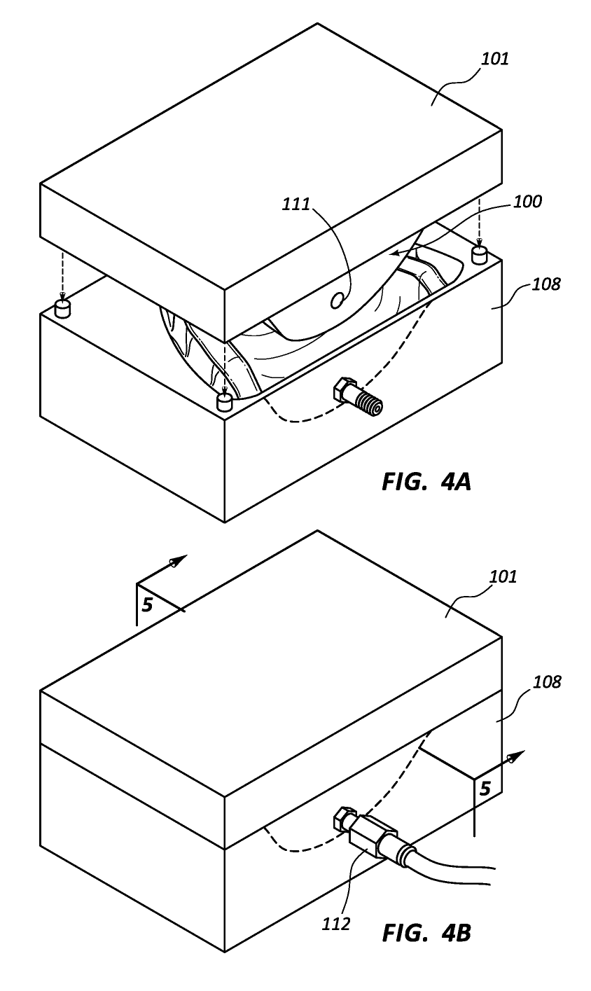

FIGS. 4A-4B show selected cavity 100 being positioned adjacent and over correspondingly shaped and sized core 108. As seen in FIGS. 4A-4B, core 108 may include an inlet 112 that may be in fluid communication with a corresponding inlet 111 of cavity 100 when aligned as shown in FIG. 4B. When so positioned, cavity 100 and core 108 define therebetween a molding void 110 into which a denture-base colored molding material may be injected (e.g., through inlets 111 and 112).

Core 108 and cavity 100 may be formed of metal (e.g., steel) or another suitable rigid material for injection molding. The cavity 100 may receive core 108.

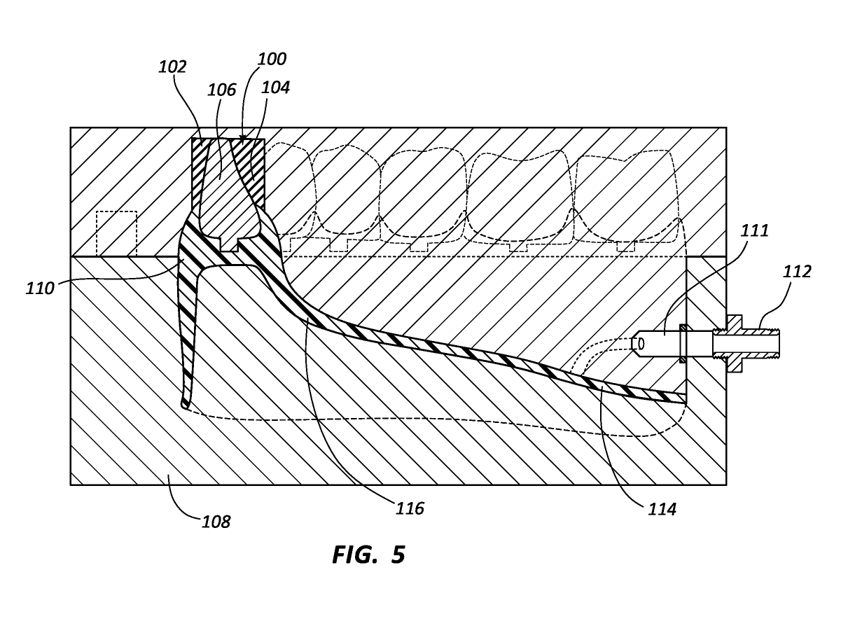

FIG. 5 shows a cross-sectional view through cavity 100 and core 108, where molding void 110 is defined between cavity 100 and core 108. Denture teeth 106, initially retained within wells 102 of cavity 100 are oriented so that the proximal aspects of denture teeth 106 are exposed within molding void 110. As denture-base colored molding material 114 is introduced into molding void 110 (e.g., through inlets 111 and 112), molding material 114 envelops the proximal aspects of denture teeth 106. Molding material 114 fills void 110, filling adjacent liner 104 and the sidewalls of wells 102. The liner 104 and the sidewalls of wells 102 provide the boundary for shaping molding material 114 to mimic the gingiva, including the interdental papilla and gingival cuff surrounding each denture tooth 106.

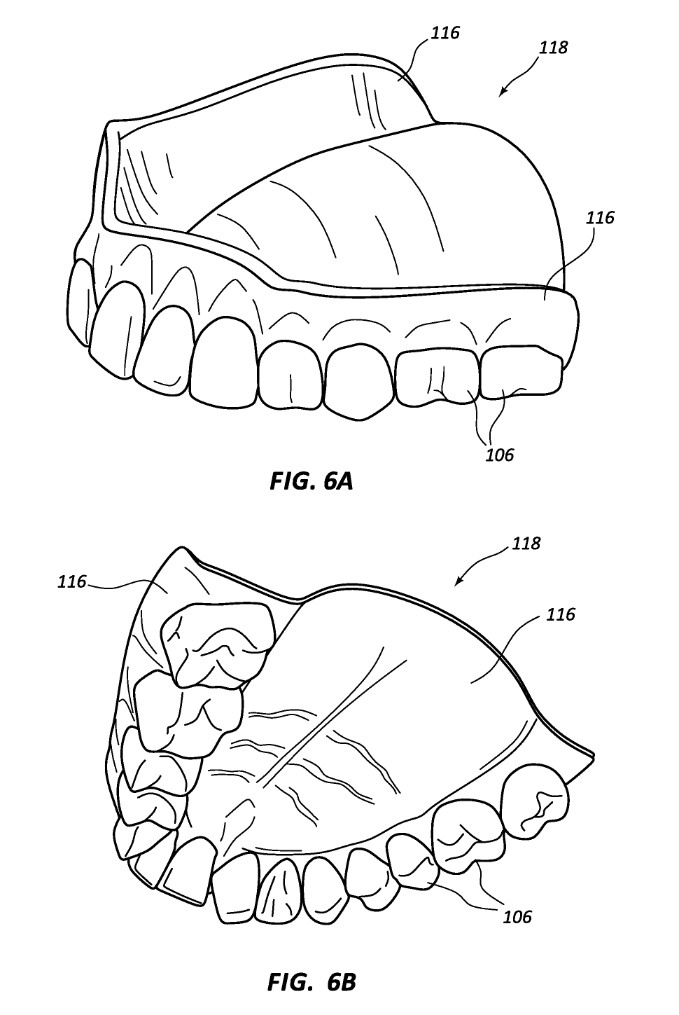

As molding material 114 at least partially sets (e.g., cools and hardens), it forms a denture base 116 within which denture teeth 106 are retained. The proximal aspects of the denture teeth 106 may be shaped to include an undercut portion or an increasing taper (e.g., increasing width towards the distal end) so as to be better retained within hardened molding material 114. An exemplary molded upper denture is shown in FIGS. 6A-6B.

In an embodiment, denture base 116 may comprise two or more at least partially set resins. For example, a first injected resin for enveloping and retaining denture teeth 106 may plastically deform less readily (e.g., soften at a higher temperature) than a second injected resin for forming the remainder (e.g., particularly those portions of denture base 116 that contact the patient's edentulous alveolar ridge) of denture base 116. Such a first injected resin may be thermoplastic, or may not even be capable of plastic deformation (e.g., it may be a thermoset resin that is not readily rendered plastically deformable, similar to acrylics used in conventional denture bases). Such an embodiment may better retain denture teeth 106 within a portion of denture base 116 that is not plastically deformable, e.g., at least at the temperatures used to heat soften the remaining portions of denture base 116 during semi-customization to the patient's alveolar ridge or the stone mold, at least in embodiments where plastic deformation is achieved through heating.

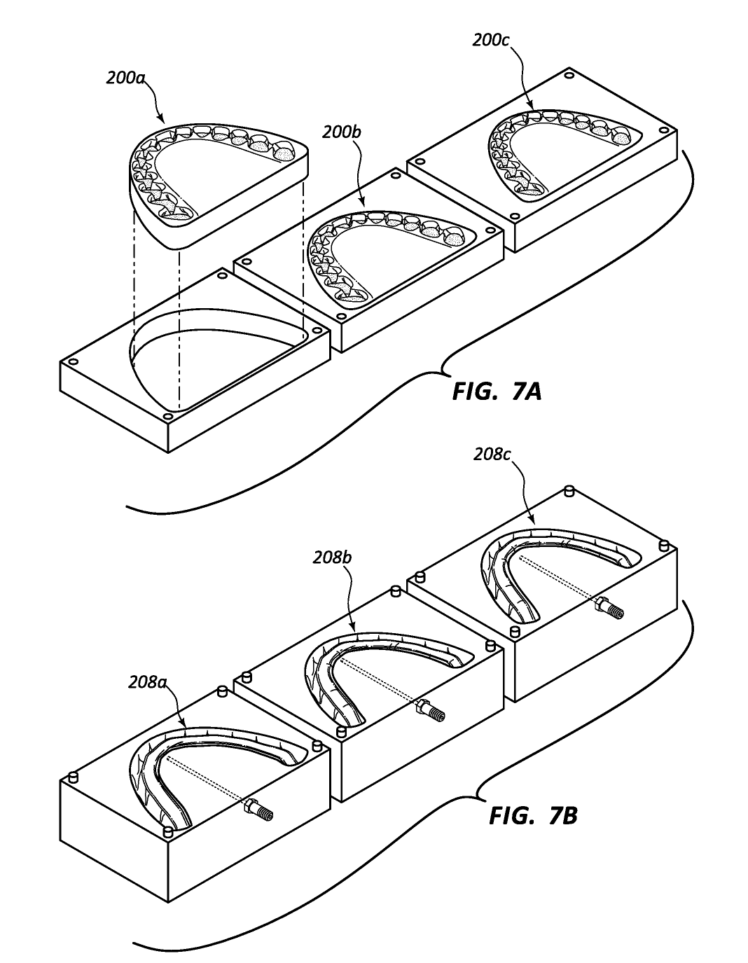

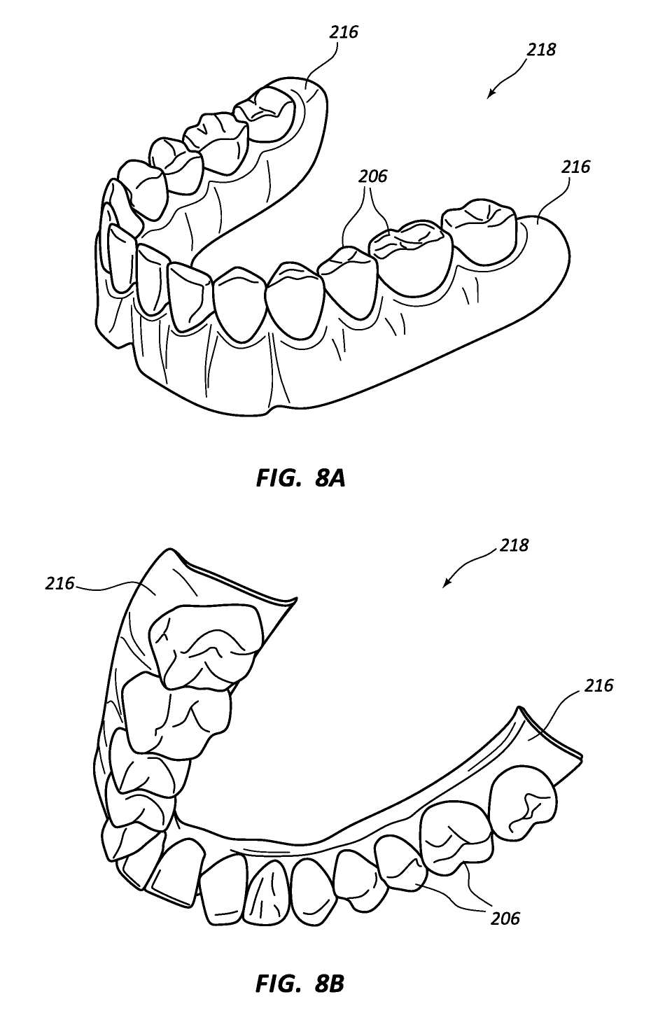

Once denture base 116 has hardened, the denture base 116 with its retained denture teeth 106 may be removed from core 108 and cavity 100. FIGS. 6A and 6B show perspective views of an exemplary resulting molded upper denture 118, including a denture base 116 with denture teeth 106 retained therein. Lower dentures may be fabricated by a similar mass-manufacturing process. For example, FIGS. 7A and 7B show cavities 200a-200c and corresponding cores 208a-208c for use in mass-manufacturing lower dentures in a plurality of different sizes. FIGS. 8A and 8B illustrate perspective views of a resulting lower denture 218 that may be formed from a selected cavity and corresponding core selected from cavities 200a-200c and corresponding cores 208a-208c, respectively.

Because at least a portion of the denture base 116, 216 comprises material that can be rendered plastically deformable to allow for semi-customization, denture base 116, 216 may advantageously be semi-customized (e.g., following heating) to the stone mold of the patient's mouth or to the actual alveolar ridge of the patient. For example, denture 118 or 218 may be contacted (e.g., submerged) with boiling or other hot water, heated with a heat gun, heat lamp, or other means to soften the denture base, rendering it plastically deformable, allowing the practitioner or user to plastically deform and conform the denture base in a more customized manner to the patient's actual alveolar ridge. Such semi-customization is not possible with existing thermoset denture base materials, which are not plastically deformable. While plastic deformation is described as being induced principally by heating, it will be appreciated that other methods may also be employed (e.g., chemical treatment, or other). For example, it may be possible to provide denture base 116 in a partially set state, where it is plastically deformable so as to allow semi-customization. Following the semi-customization to the patient, the denture base may be fully set (e.g., exposure to curing UV light wavelengths, chemical setting, etc.).

In an embodiment, molding material 114 of denture base 116, 216 may soften or otherwise be plastically deformable so as to allow plastic deformation by pressing the denture base 116, 216 against the stone mold or patient's oral anatomy (e.g., their edentulous alveolar ridge) using suitable tools or the patient's or practitioner's fingers.

In an embodiment, molding material 114 may soften so as to become plastically deformable at a temperature of not more than about 100° C., but at a temperature greater than body temperature (i.e., 37° C.), e.g., greater than 40° C., or greater than about 50° C. In an embodiment, the thermoplastic material may become plastically deformable at a temperature from about 50° C. to about 100° C., from about 60° C. to about 100° C., from about 85° C. to about 100° C., or from about 85° C. to about 90° C. Exemplary thermoplastic resins include, but are not limited to, thermoplastic acrylic materials, thermoplastic polycarbonates, thermoplastic nylons, polyethylene, polypropylene, polystyrene, polyvinyl chloride, and others. Various thermoset resins capable of plastic deformation after at least partial setting may similarly be employed.

Denture teeth 106 may be formed of a material that is not plastically deformable (e.g., not heat softenable). In another embodiment, denture teeth 106 may be formed of a thermoplastic or other plastic resin molding material that can be rendered plastically deformable, but that becomes plastically deformable at a temperature greater than the softening or plastic deformation temperature of the molding material of the denture base. For example, denture teeth 106 may be formed of a material that does not become plastically deformable upon exposure to a temperature of about 100° C. For example, where a thermoplastic material is employed in manufacturing denture teeth 106, they may comprise a thermoplastic resin that becomes plastically deformable at a temperature that is greater than about 100° C. Thus, in an embodiment, denture teeth 106 and denture base 116 or 216 may comprise different thermoplastic materials having different heat or otherwise induced plastic deformation characteristics. Alternatively, of course, denture teeth may comprise a tooth-colored molding material that is not plastically deformable at any temperature (e.g., some thermoset materials, ceramic, porcelain, dental composites, etc.).

In addition to the ability to semi-customize denture base 116, 216 through plastic deformation, the practitioner may remove portions of molded denture base 116, 216 to manipulate a shape of the denture base so as to better accommodate fit to a user. For example, the practitioner may first remove portions of the as molded denture base 116, 216, followed by heating and plastically deforming the resulting denture base to achieve a semi-custom fit to the patient's mouth or the stone mold thereof. Of course, removal of select portions of denture base 116, 216 may also proceed before and/or after plastic deformation.

FIGS. 9A and 9B illustrate kits including a plurality of differently sized dentures that may be formed according to the presently described manufacturing methods, and which allow a practitioner to select the most appropriate size and fit available from the pre-fabricated dentures. For example, FIG. 9A shows a plurality of upper dentures 318a-318c, each of a different size, provided as part of a kit. For example, upper denture 318c may have a width that is greater than upper denture 318a and upper denture 318b, while upper denture 318b may have a width that is less than upper denture 318a and 318c (i.e., upper denture 318b may be smallest, and upper denture 318c may be largest). Such dentures may be prefabricated (e.g., mass produced under carefully controlled conditions), allowing a practitioner to select the denture providing the best fit from among those of the kit (e.g., the smallest sized prefabricated denture that fits over the patient's alveolar ridge without substantial pressure.

The denture base 316 of each of dentures 318a-318c advantageously comprises a plastically deformable material, e.g., that may be rendered plastically deformable by heating within the temperature ranges described above (e.g., at a temperature below 100° C.) to permit semi-customization of the prefabricated denture to an alveolar ridge and surrounding anatomy of a patient. For example, such semi-customization may be performed on a stone mold including one or more of the patient's alveolar ridge, palate, or surrounding tissues. According to such an embodiment, the practitioner may select the prefabricated denture which provides the closest available fit the alveolar ridge of the patient. Once selected, portions of the denture may be removed (e.g., using a knife, dental burr, or other tool), as desired, and the denture base may be plastically deformed to semi-customize it to the patient's alveolar ridge and surrounding anatomy using the stone mold.

FIG. 9B illustrates corresponding lower dentures 418a-418c that may be similarly selected from and semi-customized. Lower dentures 418a-418c exhibit similar relative size characteristics as described above relative to the upper dentures of FIG. 9A (i.e., lower denture 418b may be smallest, lower denture 418c may be largest, with lower denture 418a being intermediate the other two). While 3 denture sizes for each of upper and lower positions are shown in FIGS. 9A-9B, it will be appreciated that other numbers of differently sized dentures may be provided (e.g., 4 or more, 5 or more, etc.). Thus, lower dentures 418a-418c may differ from one another in one or more of dental arch length, radius of curvature to the dental arch, or arch widths. They may also differ from one another in tooth size for a given tooth position. Similar differences may be present in the plurality of upper dentures 318a-318c.

While described in the context of preparation of full upper and lower dentures, it will be understood that kits, manufacturing methods, and injection molding tools similar to those described herein could be employed in the preparation of partial dentures.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for manufacturing a denture comprising a denture base and one or more denture teeth retained therein, the method comprising:
placing one or more denture teeth into corresponding wells in a cavity of a mold such that distal coronal aspects of each of the one or more denture teeth is disposed within the corresponding well and proximal aspects of each of the one or more denture teeth are exposed;
positioning a core of the mold including aspects of an alveolar ridge with respect to the cavity of the mold so as to form a molding void between the core, the cavity, the aspects of the alveolar ridge and the proximal aspects of the one or more denture teeth being exposed within the molding void;
at least partially filling the molding void with a molding material to form a denture base enveloping the proximal aspects of the one or more denture teeth; and
causing or allowing the molding material to at least partially set to form a denture including the one or more denture teeth retained within the denture base;
wherein the molding material is plastically deformable so that the denture base can be plastically deformed and semi-customized to an alveolar ridge of a person.

2. The method of claim 1, wherein the molding material is a thermoplastic resin.

3. The method of claim 2, wherein the thermoplastic resin of the denture base softens at a temperature of not more than about 100° C.

4. The method of claim 2, wherein the thermoplastic resin of the denture base softens at a temperature from about 85° C. to about 100° C.

5. The method of claim 1, wherein the cavity and core of the mold comprise a rigid material.

6. The method of claim 5, wherein the rigid material comprises metal.

7. A method for manufacturing a denture comprising a denture base and one or more denture teeth retained therein, the method comprising:
introducing one or more tooth-colored molding materials into one or more wells in a cavity of a mold, each of the wells having a shape of a tooth, the one or more tooth-colored molding materials at least partially setting to form denture teeth retained within the cavity;
positioning the cavity having the denture teeth retained therein adjacent to a core of the mold, the core including aspects of an alveolar ridge therein, so as to form a molding void between the cavity and the core of the mold, the aspects of the alveolar ridge and proximal aspects of the one or more denture teeth being exposed within the molding void;
at least partially filling the molding void with a denture-base colored molding material to form a denture base enveloping the proximal aspects of the one or more denture teeth;
causing or allowing the denture base-colored molding material to at least partially set to form a including the one or more denture teeth retained in the denture base.

8. The method of claim 7, wherein the one or more tooth-colored molding materials from which the denture teeth are formed does not soften upon exposure to a temperature of about 100° C.

9. The method of claim 7, wherein the one or more tooth-colored molding materials from which the denture teeth are formed comprises a thermoplastic resin that softens at a temperature that is greater than a temperature at which the denture base-colored molding material becomes plastically deformable.

10. The method of claim 7, wherein the cavity and core of the mold comprise metal.

11. A tool for use in mass manufacturing a denture comprising a denture base and one or more denture teeth retained therein, the tool comprising:
a plurality of denture manufacturing molds, each of a different size, each denture manufacturing mold comprising:
a cavity having a plurality of wells formed therein, the wells corresponding to teeth of a denture to be formed; and
a core corresponding in size and shape to the cavity and including aspects of an alveolar ridge, a molding void defined between the cavity and the corresponding core when positioned adjacent one another.

12. The tool of claim 11, further comprising an elastomeric lining material within the plurality of wells that aids in temporarily retaining denture teeth within the wells during manufacture of a denture.

13. The tool of claim 11, further comprising one or more denture teeth for placement into the wells of the cavity.

14. The tool of claim 11, further comprising a denture-base molding material for introduction into the molding void, the molding material becoming plastically deformable at a temperature from about 85° C. to about 100° C. after having been set.

15. The tool of claim 14, further comprising one or more tooth-colored molding materials different than the denture-base molding material, for insertion into one or more of the wells and configured to set within the wells to form denture teeth.

16. A kit for use in forming a semi-custom-fitted denture to a patient, comprising:
a plurality of prefabricated dentures, each of a different size, each prefabricated denture comprising:
a plurality of denture teeth; and
a denture base in which the denture teeth are at least partially embedded, the denture base comprising a material that becomes plastically deformable at a temperature below 100° C. so as to permit semi-customization of the prefabricated denture to an alveolar ridge of a patient.

17. A method for providing a prefabricated denture selected from a plurality of differently sized prefabricated non-custom dentures, the method comprising:
providing a kit including a plurality of prefabricated dentures of different sizes as recited in claim 16; and
selecting a prefabricated denture from the plurality of dentures that provides the closest available fit to a patient's alveolar ridge from among the plurality of prefabricated dentures.

18. The method of claim 17, further comprising removing portions of the denture base to manipulate a shape of the denture base to better accommodate fit to a user.

19. The method of claim 17, further comprising heating the denture to render the denture base plastically deformable to allow a practitioner to manipulate a shape of the denture base to better accommodate fit to a user.

20. The method of claim 19, wherein heating the denture is achieved by contacting the denture with hot water.

21. The method of claim 17, wherein the denture teeth comprise a material that does not become plastically deformable upon exposure to a temperature of about 100° C.

22. The method of claim 21, further comprising heating the denture to render the denture base plastically deformable without rendering the denture teeth plastically deformable to allow a practitioner to manipulate a shape of the denture base to better accommodate fit to a user.

23. The method of claim 21, further comprising heating the denture to render the denture base plastically deformable to allow a practitioner to manipulate a shape of the denture base to better accommodate fit to a user, wherein the material of the denture base becomes plastically deformable at a temperature of not more than about 100° C.

24. The method of claim 21, further comprising heating the denture to render the denture base plastically deformable to allow a practitioner to manipulate a shape of the denture base to better accommodate fit to a user, wherein the material of the denture base becomes plastically deformable at a temperature from about 85° C. to about 100° C.

25. The method of claim 17, wherein the kit including a plurality of prefabricated dentures includes 3 or more prefabricated dentures of different sizes.
